(19) United States
(12) Patent Application Publication
(10) Pub. No.: US 2009/0160727 A1
(43) Pub. Date: Jun. 25, 2009

(54) EZ fit antenna base (top mount)

(76) Inventor: Barry Booth, West Palm Beach, FL (US)

Correspondence Address: Barry, 7135 Coconut Blvd, West Palm Beach, FL, 33412, US

(21) Appl. No.: 12/214,141

(22) Filed: Jun. 17, 2008

Related U.S. Application Data
(60) Provisional application No. 60/937,692, filed on Jun. 29, 2007.

(51) Int. Cl. H01Q 1/12

(52) U.S. Cl. 343/880

(57) ABSTRACT

EZ fit antenna base (top mount) is an apparatus for securing an antenna to a surface, mainly a top surface, flat or cambered. Allowing for unlimited vertical adjustment for positioning of the antenna, with hollow construction to facilitate an internal cable run, A single hole mounting operation. A one nut securing process for effortless installation. A method of attaching an antenna or other object without the use of screws or bolts, and constructed in stainless steel, or other material. could be used with almost any standard antenna, the antenna could still be laid flat to pass under low structures, because of the one hole installation process it would minimize areas for water penetration, a beautiful streamline appearance and ease of manufacture.

### CROSS REFERENCE TO RELATED APPLICATIONS

This is a continuation of Ser. No. 60/937,692, filed on Jun. 29, 2007, and is also based on provisional application Ser. No. 60/937,692, filed on Jun. 29, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of marine electronics and more specifically to the EZ fit antenna base (top mount). An apparatus for attaching an antenna to a surface, usually a top surface of a boat, whereas the surface would normally be slanted or cambered in one or more directions. The said apparatus not only being the means of attachment, but also the means of unlimited vertical adjustment of the antenna, and also the means of hinging the antenna for lowering purposes to pass under obstructions such as bridges overhead wires and the likes, and a way to lock the antenna upright when underway.

The said apparatus would also provide a means of routing the antenna cable, usually a coax, through the center of all parts of the mounting system, without compromising the ability to lower the antenna, or adjust the vertical angle desired, it would also enhance the appearance of the boat, be simple to manufacture and easy installation by means of a single hole, no screws or bolts, which could easily be accomplished by one relatively unskilled person. antenna mounts were invented many years ago to mount communication antennas on boats and other structures, in the marine world the looks were not important as at the time boats were used for work only, transporting goods, fishing and the likes. However in recent times boats have become works of art, appearance being at the top of the list for most boat owners, but the technology for antenna mounting somehow got left behind, even though the looks of antenna mounts improved by means of using polished stainless steel and chrome plated brass the design never really changed, they still look clumsy, are difficult to install, leak water through the many screw holes needed to secure them, and have ugly and dangerous (trip hazards) external cable routing. The prior technology, even though quite adequate for holding an antenna in place, is totally out of place on the modern high tech vessels now being produced for the articulate boat owner and his/her crew. There has now become a need for a means to secure the latest high tech and expensive antennas, that will not only enhance the the appearance of the boat, but will make the immediate area safer for the crew members by concealing the antenna cable and therefore preventing crew or items becoming entangled as often happens with all prior technology. Also all antenna mounts available until now require approximately eight holes to be drilled through the mounting surface, all of which are potential future leaks, not to mention expensive antennas being lost due to screws coming loose because of vibration and wind stress, resulting in loss of essential communications to the boat in question. the main deficiencies in prior technology are installation weaknesses, when any object, especially a very long object is secured at the base only, on a moving object, the swaying effect exerts tremendous stress on the said base, in this case the antenna mount, these are normally secured by self tapping screws to the surface, when these screws start to loosen they leak water, often causing severe damage to the inside of the boat, they sometimes even break loose causing whiplash damage to the exterior of the boat until the cable snaps and then the expensive antenna is lost completely. The EZ fit antenna base overcomes all these problems, it is secured through just one hole in the surface and through-bolted, there is a gasket to prevent water leakage permanently, and the strength is far greater than any prior technology.

All prior technology has external cable routing, this is not only unsightly, but a dangerous trip hazard for cleaning crews and the like, it also allows weather damage to the cable where exposed, not to mention extra holes in the surface for cable entry. The EZ fit antenna base overcomes this problem by means of a hollow construction to allow the antenna cable to be routed internally, completely out of sight and harms way, after all we don't see the wire runs in out homes, or even inside our boats, so why see them on the outside.

Another deficiency in prior technology is the difficulty to install, approximately eight holes have to be accurately marked and drilled, then wedges have to be made to vertical position the antenna, this is because all prior technology relies upon a tooth engagement system for vertical adjustment, and therefore only very rarely works for perfect positioning, especially when more than one antenna are to be installed. The EZ mount antenna base has a infinite vertical adjustment that can be set at any angle without wedges, and of course it is installed through a single hole, with no other holes to line up.

Also the EZ mount antenna base is designed for appearance, now screws or bolts to rust, even stainless steel screws rust, that why they are called stain less, no cable popping out of the side of the antenna, forming a massive loop and then disappearing inside the boat. Note that all standard antennas are made so the cable can be internal, this is done for the sole reason to enable it to be installed on an extension piece to make the antenna higher and therefore more affective, with the prior technology though the cable has to be made to exit the side of the extension piece and enter the boat in a remote location.

Please note that above I have refereed to the EZ mount antenna base being installed on a boat, but it could also be used on any other structure where an antenna is required, or for holding any other object other than an antenna is so required.

### BRIEF SUMMARY OF THE INVENTION

The primary object of the invention is to provide a better antenna mount with ease of installation.

Another object of the invention is completely conceal the coax cable from sight.

Another object of the invention is minimize the number of holes drilled in the surface for installation.

A further object of the invention is Improve the appearance.

Yet another object of the invention is Make the vertical positioning exact instead of close.

Still yet another object of the invention is make installation possible without the use of any screws or bolts.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed EZ fit antenna base (top mount) comprising: An apparatus for securing an antenna to a surface usually a top surface such as a roof, which would allow for unlimited vertical adjustment for positioning the said antenna to a vertical, or other desired angle, with a hollow construction to facilitate internal cable routing. A single hole mounting operation with a one nut securing process for effortless installation. Also a method of attaching an antenna without the use of screws or bolts to secure it to the surface, and constructed in stainless steel, or other alloy, or any other material for part of or entire apparatus. The said apparatus can also be used to mount an item other than an antenna. The apparatus could also be used with external cable routing, and the apparatus could be secured through the surface by other means than a single nut.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Drawing A is a side, front, top, end, plan, and sectional views of the invention.

FIG. 1 Is a top top view, without the actual antenna mount in place (FIG. 2)

FIG. 2 Is a side view of the hollow antenna mount with quick release handle for antenna lowering (can be substituted with alternate antenna mount drawing B)

FIG. 3 Is the end view fully assembled with only the antenna mount (FIG. 2) missing, the dotted line shows where FIG. 2 goes.

FIG. 4 Is the end view of the top side, with the antenna mount (FIG. 2) and the hinged backplate (FIGS. 5&6) absent.

FIG. 5 Is the plan of the top part of the hinged backplate assembly.

FIG. 6 Is the plan of the bottom part of the hinged backplate assembly.

FIG. 7 Is the section AA shown in FIG. 1, depicting the area opened up to allow sideways movement (70).

25. Is the hinged backplate assembly.

30. Is the outer casing.

35. Is a standard antenna thread to fix any standard antenna onto.

40. Is the quick release handle used to lower the antenna for stowage or passing under obstacles.

45. Are the serrations to keep the upper and lower parts of the antenna mount at any fixed angle desired.

50. Are the through mount fixing nut and washer, with gasket if required.

55. Is the adjusting screw that sets the vertical angle prior to the fixing nut (50) being fully tightened.

60. Is the groove in the top part of the hinged backplate to facilitate the open end of the adjusting screw (55).

65. Is the welded on nut, or the threaded hole in the bottom part of the hinged backplate for the adjusting screw.

70. Is the opened up, or flared area in the outer casing (30) to allow for vertical alignment of the antenna.

75. Is the horizontal adjustment bar that can turn inside the outer casing to allow for vertical alignment of the antenna.

80. Is the hollow transition tube for the internal cable routing, it can be part of the horizontal adjustment bar (75) or just attached.

85. Are the elongated holes for the transition tube to pass through and allows for some sideways adjustments.

90. Is the space where the mounting surface would be showing an exaggerated angle that could be achieved.

95. Is a gasket to prevent water penetration when all the parts are finally clamped together.

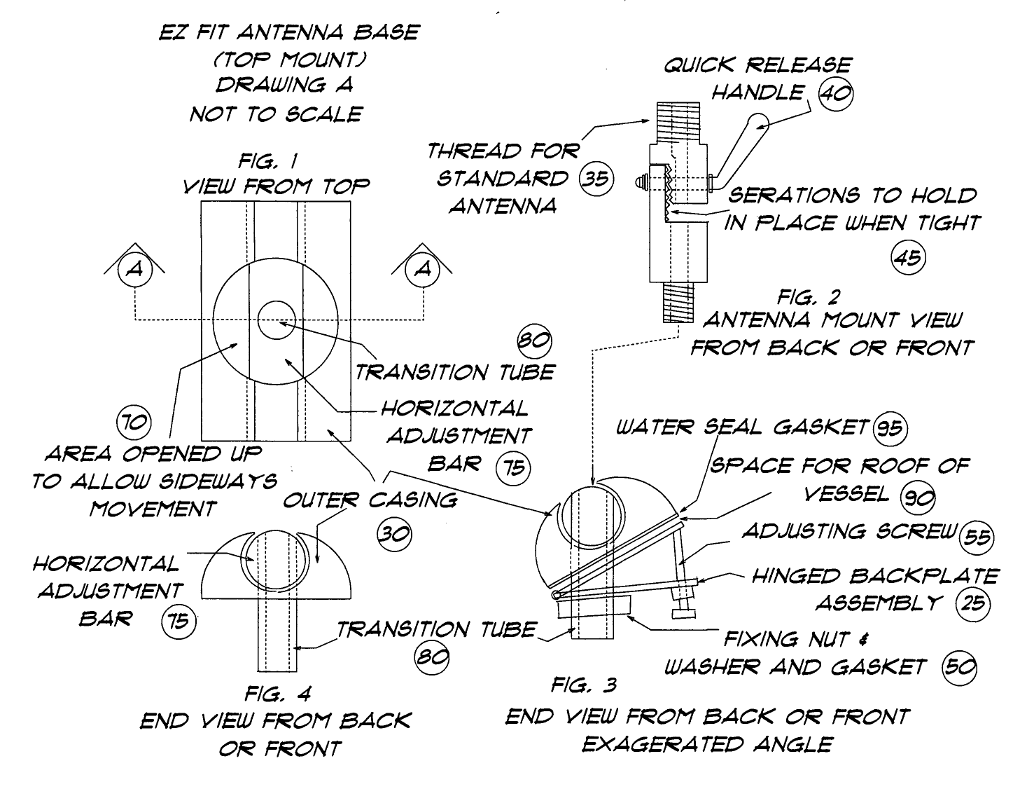

Drawing B is rear, side, end, front, top and perspective views of the alternate antenna mount. Which could replace FIG. 2 Drawing A

FIG. 8 Is a rear view (61) of the alternate antenna mount.

FIG. 9 Is the side view (56) of the alternate antenna mount.

FIG. 10 Is the front view (81) of the alternate antenna mount with its ferrel/sleeve (76) in place.

FIG. 11 Is the front view ferrel/sleeve (76), the dotted lined arrow showing its final location.

FIG. 12 Is an alternate bottom of the alternate antenna mount, with optional cambered bottom (26) to fit over outer casing (31).

FIG. 14 Is a top view of FIG. 10 with ferrel/sleeve ( 76) in place.

FIG. 15 Is a top view of the ferrel/sleeve (76).

FIG. 16 Is a side view of the transition tube (80).

FIG. 17 Is a view of FIG. 8 from the top.

FIG. 18 Is a view of FIG. 9 from the top.

FIG. 19 Is a perspective view of the alternate full outer casing (31).

26. Is the optional cambered bottom.

31. Is the full outer casing.

35. Is the hole for the antenna cable.

36. Is the raised collar.

41. Is the top part of the alternate antenna mount.

46. Is the bottom part of the alternate antenna mount.

51. Is the front view of the optional bottom part of the alternate antenna mount.

56. Is the side view of the alternate antenna mount.

61. Is the rear view of the alternate antenna mount.

66. Is the hole for the antenna cable.

71. Is the pivot pin, side and end view, with an arrow showing where it goes.

75. Is the horizontal adjustment bar.

76. Is the ferrel/sleeve.

80. Is the transition tube.

81. Is the front view of FIG. 10.

Drawing C is a side, front, top, sectional, and perspective view of the alternate outer casing.

FIG. 13 Is an alternate bottom (46) with a domed bottom to fit over the alternate outer casing FIG. 21.

FIG. 16 Is the transition tube (80).

FIG. 19 Is the alternate full outer casing (31).

FIG. 21 Is the alternate circular outer casing.

FIG. 22 Is section AA of the alternate circular outer casing FIG. 21 with transition tube (80) and adjustment wedges FIG. 24. in place.

FIG. 23 Is the same as FIG. 22 with the bottom of the antenna mount (46) in place.

FIG. 24 Are the adjustment wedges, top view (41) and side view (32).

27. Is the top view of the alternate circular outer casing.

31. Is the full outer casing.

32. Is the side view of the adjustment wedges FIG. 24.

37. Is the front view of the section through AA of the alternate circular outer casing FIG. 21.

42. Is the side view of the alternate circular outer casing FIG. 21.

46. Is the bottom, the bottom part of the alternate antenna mount.

47. Is the top view of the circular adjustment wedges FIG. 24.

52. Is the front view of the section through AA of the alternate circular outer casing FIG. 21. with bottom of antenna mount (46) attached.

57. Is the alternate domed bottom of the antenna mount.

62. Depicts a surface the invention is mounted to.

66. Is the hole for the antenna cable.

75. Is the horizontal adjustment bar.

80. Is the transition tube.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This invention is an apparatus for securing an antenna, or other object to a surface, usually a top flat or cambered surface of a boat, notably a roof like structure or hard top, but not limited to marine use. The said surface 90 (space for roof of vessel) drawing A, could be on any structure or body. The apparatus would normally be constructed in metal, such as stainless steel, alloy, brass or bronze, and chrome plated or anodized to enhance the appearance, but would not be limited to metal, any other material deemed suitable could be substituted for all or part of the said apparatus to be used in its construction.

The said apparatus is the EZ fit antenna base, and will known as the antenna mount from this point forward comprising of four main parts, the outer casing 30, the horizontal adjustment bar 75 with transition tube 80 attached by means of threading or similar means, the hinged backplate assembly 25, which is basically an adjustable wedge to set the infinite vertical adjustment of the antenna, and the hollow antenna mount itself FIG. 2, complete with its own antenna lay down system.

Turning first to drawing A, FIG. 3 we see the entire assembled apparatus, viewed from directly behind or from directly in front, a front or rear elevation so to speak, with an exaggerated angle and fixed to an imaginary sloping surface (space for roof of vessel) 90. There is a dotted line connecting FIG. 2 to FIG. 3 which indicates the positioning of the antenna mount FIG. 2 The antenna mount FIG. 2 has two main parts, the upper part which is threaded to accept a standard antenna 35, and a lower part which is made to fit into the horizontal adjustment bar 75, the two parts are hollow as depicted by the dotted lines and joined by a serrated area 45, and quick release handle 40, which will facilitate fast and easy lowering and raising of the antenna to clear obstacles or for stowage. below the space for roof of vessel 90 is the hinged backplate assembly 25 with its adjusting screw 55, which will act as an adjustable wedge, the turning of the adjusting screw 55 would alter the angle of the wedge which in turn would set the vertical adjustment of the antenna by means of rotating the horizontal adjustment bar. Tightening the fixing nut with washer and gasket 50, would then permanently set the exact vertical positioning of the antenna. The water seal gasket 95 would ensure the inside of the boat or structure would remain dry permanently.

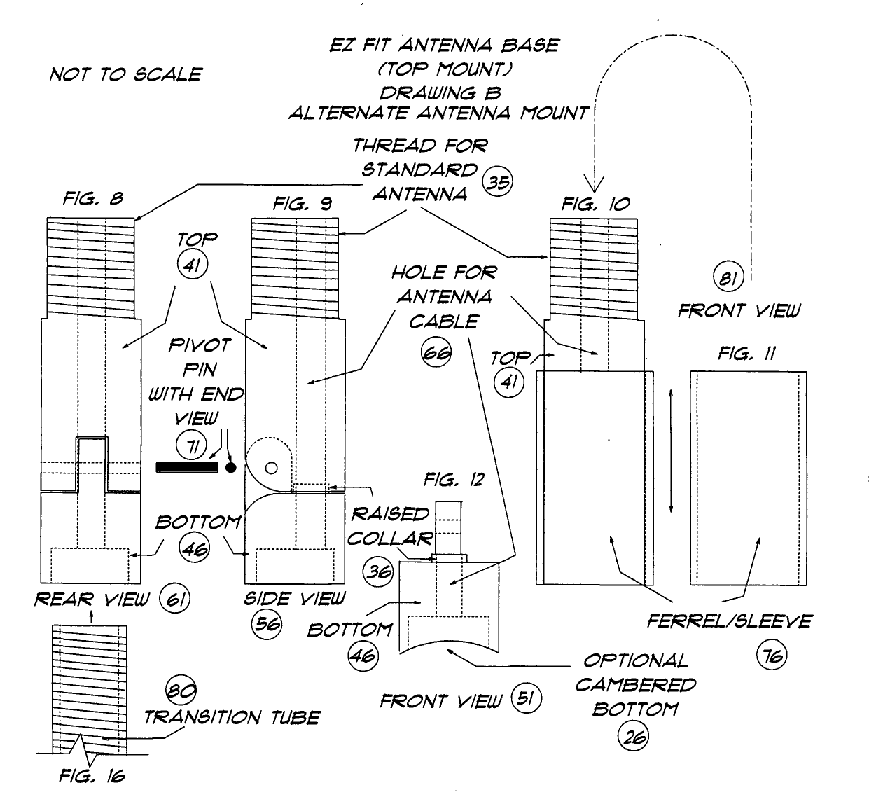

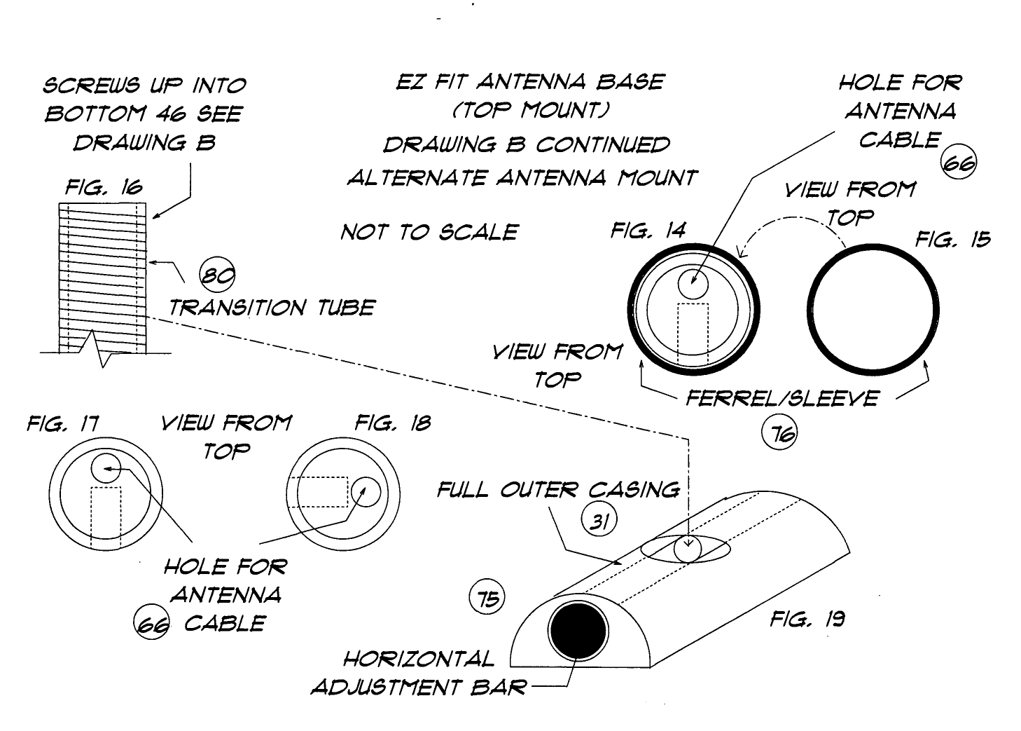

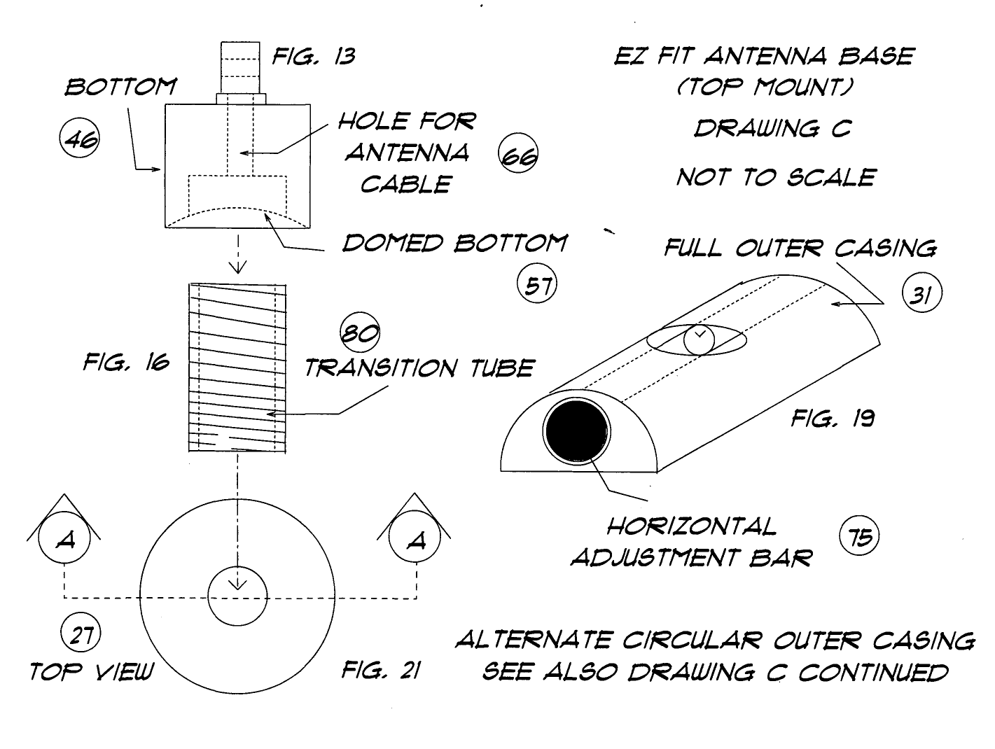

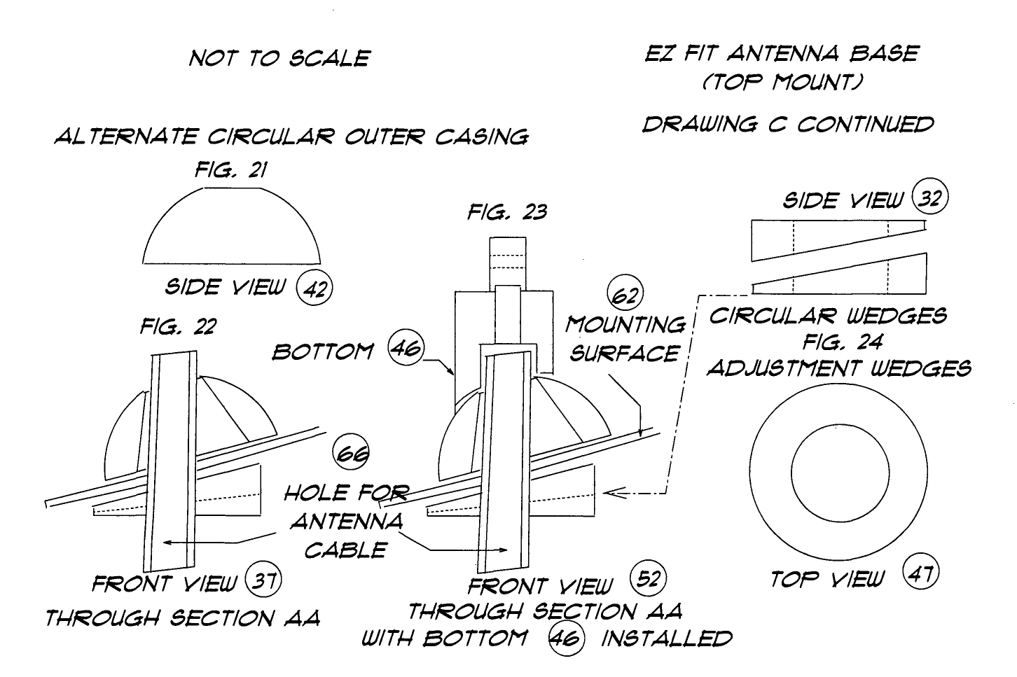

Turning to FIG. 1, this is a plan view or a view from the top that shows the outer casing 30, and the horizontal adjustment bar 75 with its hole through the center for attaching the antenna mount FIG. 2 and the transition tube 80, both of which are hollow to facilitate an internal cable run. The opened up area 70 in the center would allow for extra clearance if mounted at an unusually steep angle. The outer casing 30 could have fully enclosed ends if desired so the top of the horizontal adjustment bar would only show at the area opened up to allow sideways movement 70 area. FIG. 7 is a view through section AA in FIG. 1 and again shows the area opened up to allow extra sideways movement 70. FIG. 4 is an end view from the front or back of the top part of the apparatus, showing the outer casing 30, the horizontal adjustment bar 75 and the transition tube 80.

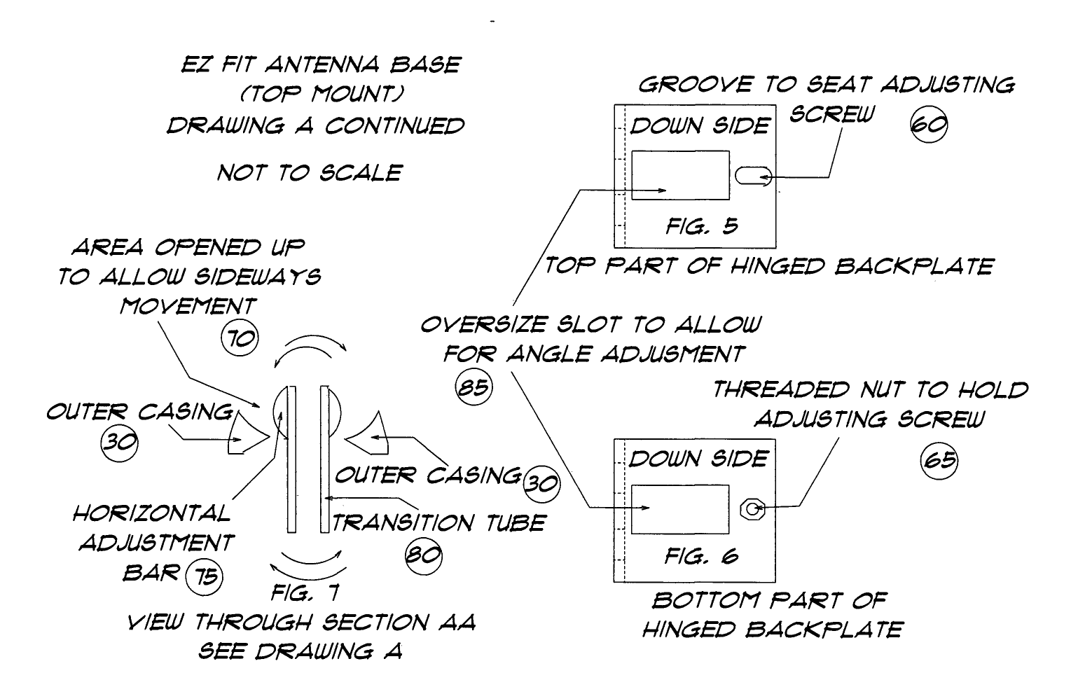

In accordance with an important feature of the present invention, there is shown in FIG. 5 and FIG. 6 the top and bottom part of the hinged backplate when joined with a pin, similar to a hinge along one long edge, forms the unlimited infinite adjustable wedge, that takes up the camber or slope of the top surface, allowing the antenna to stand upright, and not just at a ninety degree angle from where it is mounted, or to the nearest notch as with prior art. The top part would have an elongated hole 85 to allow the transition tube 80 to obtain the desired angle, and a groove to seat the adjusting screw 60. The bottom part would have an elongated hole that lines up with the elongated hole in the top part also to allow the transition tube 80 to have clearance for adjustment, and would have a threaded hole, or a nut attached to allow the adjustment screw 55 to be moved in or out to set the infinite angle of the hinged backplate FIG. 5 and FIG. 6 and as shown in an exaggerated adjusted position in FIG. 3.

The whole apparatus known as the antenna mount would probably be delivered assembled in two main parts ready for mounting, the upper part, which would consist of the outer casing 30, the transition tube 80, the horizontal adjustment bar 75, and the antenna mount FIG. 2 and the lower part, the hinged backplate assembly 25 complete with it's adjusting screw in place. All the installer would have to do is drill a single hole in the surface where it is to be located, drop the upper part through the hole with the gasket 95 in place, offer up the hinged backplate assembly 25, and add the fixing nut with its washers 50. Before tightening the fixing nut 50 he would turn the adjusting screw to set the correct vertical adjustment required. The actual antenna could then be screwed onto the thread for standard antenna 35, with it's cable passed down the hollow parts. The antenna coax cable would then be on the inside of the surface ready to connect to the radio or other electronic device, without being seen from the exterior at all. In all prior art the antenna cable exits the antenna on the side and enters the boat or structure at a remote location, creating an unnecessary potential water leakage area, an unsightly appearance and a trip hazard.

Now turning to drawing B. This is the alternate antenna mount that could replace the antenna mount FIG. 2 on drawing A. The purposes of this alternate antenna mount are 1. to streamline and enhance the appearance, no ugly handle 40 sticking out. 2. to enable the antenna cable to be completely encased, with the original mount a small amount of cable can still be seen if you look very closely where the two parts join. 3. To fully waterproof the whole apparatus, known as the EZ fit antenna base. 4. Make the lowering of the antenna an effortless operation.

Again turning to drawing B FIGS. 8 and 9 are are rear and side elevations, 35 showing the threaded area for a standard antenna, 41 is the top part of the mount and 46 the lower part, the two parts hinge together with the pivot pin 71. The dotted lines show the internal offset cable run 66, note that the bottom of the top 41 and the top of the bottom 46 are curved on one side to allow for the hinging process to take place in one direction only. FIG. 12 shows the optional cambered bottom on item 46 which if utilized would fit snugly over the alternate full outer casing FIG. 19 31. The cambered bottom could be fitted with an O ring or rubber gasket to form a watertight seal to both adjacent areas. FIG. 16 is the transition tube that the antenna mount FIG. 8 would screw onto, this would already be screwed into the threaded hole in the horizontal adjustment bar, and ready to take the nut washer and gasket as shown in drawing A FIG. 3. When tightened would lock the whole apparatus into its desired position, and vertical angle.

To accomplish an important part of the invention there is a ferrel/sleeve 76 shown in elevation in FIG. 11 with the dotted line above depicting its location over the antenna mount FIG. 10, which once in place would lock the alternate antenna mount in a vertical position, and if lifted partially would allow the said antenna mount FIG. 10 to be hinged down, which would allow the antenna to lay flat on the surface it is mounted to. FIG. 14 is a view from the top of FIG. 10, and FIG. 15 is a view from the top of FIG. 11 the ferrel/sleeve.

Turning now to FIG. 17 and FIG. 18, they are both views from the top of FIG. 8 and FIG. 9 respectively, and FIG. 19 is the alternate full outer casing 31 with its horizontal adjustment bar in place, with the arrowed dotted line showing where the transition tube 80 fits (not to scale).

Turning now to drawing C. FIG. 21 is a top view 27 of the alternate circular outer casing, and would probably be the one most used as it is the easiest to manufacture, allows for a more complex vertical multi directional adjustment due to adjustment wedges FIG. 24 being able to be rotated as well as slid together, giving unlimited adjustment in any direction, whereas the previously mentioned outer casings only give infinite sideways adjustment, and have to follow the surface longitudinally. Also this configuration is the most watertight, especially if used in conjunction with the alternate antenna mount as described above and on drawing B FIG. 10.

Going back to drawing C, FIG. 21 42 is the side view of the alternate circular outer casing, the bottom part of the antenna mount would now have a domed bottom 57 FIG. 13 to fit snuggly over the circular outer casing FIG. 21 with an O ring or rubber gasket to make the union completely watertight. FIG. 22 is a sectional view of FIG. 21 with transition tube 80 and adjustment washers FIG. 24 in place. FIG. 23 is the same as just mentioned with the addition of the bottom 46 of the antenna mount in place. The above invention is aimed at making the method of installation as easy as possible by one person without the use of screws or bolts. All cable routing would be internal, rather than external as with all prior art wherein at least some wiring is external. This invention is the only antenna mount that can claim all the above advantages.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. EZ fit antenna base (top mount) comprising:
An apparatus for securing an antenna to a surface;
Allowing for unlimited vertical adjustment for positioning the said antenna;
A hollow construction to facilitate internal cable run;
A single hole mounting operation;
A one nut securing process for effortless installation;
A method of attaching an antenna without the use of screws or bolts; and
constructed in stainless steel, or other alloy.

2. The apparatus of claim 1 used to mount an item other than an antenna.

3. The apparatus of claim 1 being constructed of any other material other than stainless steel or other alloy.

4. The apparatus of claim 1 being used with external cable routing.

5. The apparatus of claim 1 wherein the said single hole mounting operation could be multi hole.

6. The apparatus of claim 1 wherein the said one nut securing process could be multi nut.

7. The apparatus of claim 1 wherein the said attaching an antenna without the use of screws or bolts could be with screws and or bolts.

8. The apparatus of claim 1 wherein the said unlimited vertical adjustment could be limited.

9. The apparatus of claim 1 wherein the securing process could be by any other means other than a nut.
